(19) United States
(12) Patent Application Publication
(10) Pub. No.: US 2015/0089527 A1
(43) Pub. Date: Mar. 26, 2015

(54) VIEWING PROGRAM IDENTIFICATION SYSTEM, METHOD, AND PROGRAM

(71) Applicants: Hiroyuki Matsuyama, Tokyo (JP); Keigo Aoki, Tokyo (JP); Sakae Takeuchi, Tokyo (JP); Setsuo Kimura, Tokyo (JP)

(72) Inventors: Hiroyuki Matsuyama, Tokyo (JP); Keigo Aoki, Tokyo (JP); Sakae Takeuchi, Tokyo (JP); Setsuo Kimura, Tokyo (JP)

(21) Appl. No.: 14/496,591

(22) Filed: Sep. 25, 2014

(30) Foreign Application Priority Data
Sep. 26, 2013 (JP) 2013-200248

(51) Int. Cl. G06K 9/00; H04N 21/41; H04N 21/44; H04N 21/442; G06K 9/22; G06K 9/46

(52) U.S. Cl. CPC G06K 9/00744; G06K 9/22; G06K 9/46; G06K 9/00758; H04N 21/44008; H04N 21/44222; H04N 21/4126
USPC 725/19

(57) ABSTRACT

Included is a unit configured to calculate feature points of a scene image of a screen acquired from a television program that is currently on air on a given number of broadcast stations, or a simulcast distribution server at predetermined intervals, and save, in a storage unit, feature point data of a predetermined time period on a broadcast station basis; a unit configured to receive feature point data of an image of a television program currently being watched by a user, the feature point data having been transmitted from a mobile terminal of the user; and a unit configured to check the received feature point data against the feature point data saved in the storage unit and identify a scene image that satisfies a predetermined matching condition.

### BACKGROUND

1. Technical Field

The present invention relates to a system, method, and program for showing a moving image shown on a television screen of a user using a camera lens of a mobile terminal, checking feature points of one or more still images taken out from the moving image against feature points of a scene image captured from the nearest past television broadcast, and identifying a broadcast station and time that the user is currently watching in substantially real time based on the check result.

2. Related Art

It has become common to add a camera function to a mobile terminal. When the mobile terminal is moved in such a manner as to hold the mobile terminal to a shooting target object, the area that the camera lens shows is displayed in a predetermined area of the mobile terminal. As described in “Multiscreen Broadcasting Study Group Discusses Providing Synchronous Broadcasting IPDC Content,” http://itpro.nikkeibp.co.jp/article/COLUMN/20120123/379101/?ST=network, a system that uses multi-screen (a general term for double screen, triple screen, and the like) viewing has come to appear.

This is a system in which a television screen on which a television program is being broadcast is targeted for shooting, an entire area or part of the television screen shot by a mobile terminal is transmitted to a server, and information related to a content displayed on the television screen is then displayed on the mobile terminal. For example, “synchro-ad broadcasting distributing device and method” disclosed in JP 2009-278315 A is an invention related to the multi-screen technology.

In the system using multi-screen viewing, a time lag (a delay and a real time property) between the contents displayed on the television screen and the mobile terminal becomes a problem.

The invention of JP 2009-278315 A is to provide a mechanism for synchronization when using simulcast distribution to watch a main part of a broadcast on one screen and display a synchronized advertisement on another screen. Specifically, synchronization between the screen for watching the main part and the screen for displaying the synchronized advertisement is achieved by including in advance a synchronization timing signal in a distribution signal. An algorithm in which a waveform is followed in chronological order (called fingerprint technology, or the like) is used to extract the synchronization timing signal.

The mechanism (advance inclusion of a synchronization timing signal in a distribution signal) of JP 2009-278315 A has many problems in costs related to equipment and preparations, and convenience in the change of the situation. Hence, multi-screen viewing in a different synchronization method that improves such problems is proposed.

There is also a need to view related information tied to a viewing content on a mobile terminal while watching TV by receiving radio waves directly from a broadcast station and showing them on a television screen. It is important to determine that a viewer is watching a scene broadcast by which broadcast station on what time, correctly and in real time, to respond to the need.

For example, assume that a commercial of Company A is broadcast on TV, a user shoots the commercial by a mobile terminal and sends it to a server, and information sent from the server, such as a product of Company A or an event held under the sponsorship of Company A, is displayed on the mobile terminal. If the information related to Company A is still shown on the mobile terminal although the commercial of Company A has already changed to a commercial of Company B on the television screen, it may not be only ignored but even give discomfort. In order to coordinate their displays in a timely manner, it is important for the mechanism that the server can determine which television program is related to an image transmitted from the mobile terminal, correctly and in real time.

The present invention provides the mechanism, and an issue thereof is to achieve appropriate coordination between a broadcast that is being broadcast on a screen of a television, and related information displayed on a screen of a mobile terminal, acceptance of a viewer's answer to a quiz, a questionnaire, and the like in the program, real time reflection of a true-to-life voice of a viewer such as an SNS service, and the like, and to aim improvement of convenience of a multi-screen system.

### SUMMARY

To achieve the above object, a first aspect of the invention is a viewing program identification system configured to shoot a screen showing a television program that is currently on air and being watched by a user with a mobile terminal, acquire a still image from the shot moving image, and identify the television program being watched by the user in substantially real time based on feature point data calculated from the still image, the system including:

a broadcast program simultaneous reception unit configured to receive television program data that is currently on air on a given number of broadcast stations;

a feature point collection unit configured to calculate feature points of a still image of a screen (hereinafter a “scene image”) acquired from the received television program data at intervals of N seconds in real time, and save, in a storage unit, feature point data of a predetermined time period immediately before the current broadcast on a broadcast station basis;

a user viewing data receiving unit configured to receive the feature point data of the still image acquired from the television program being watched by the user, the feature point data having been transmitted from the mobile terminal of the user; and

an image search unit configured to check the received feature point data against the saved feature point data and identify a scene image that satisfies a predetermined matching condition (hereinafter the “matching scene image”) to identify the television program currently being watched by the user.

“Identification of a viewing program” is to determine which scene broadcast by which broadcast station on what time is being watched by a user, targeting programs broadcast by multiple (more than 1000 in some cases) broadcast stations. As in a sports broadcast, the duration of the broadcast may be changed so that a broadcast time of a commercial is different from a schedule. In such a case, it is sufficient if it is possible to determine which broadcast station was watched on what time. Accordingly, there is no problem that the determination of a broadcast station and viewing time is also included in the “identification of a viewing program.”

The invention allows the identification of a currently watched broadcast station and television program if a user shows (all or part of) a video of a television program that is currently on air on a screen of a mobile terminal. A “television program” includes all the contents broadcast on TV and also includes commercials.

Moreover, an object of the present invention is to identify a broadcast station, scene image of a program, and viewing time that the user is watching, in real time. Therefore, it is simply required to have only feature points of a scene image immediately before a current broadcast, as data. Only feature point data corresponding to a video of the past approximately 5 to 60 seconds at the longest is targeted for a check, and accordingly it contributes to a speed-up of the check process.

Not image data but feature point data is transmitted from the mobile terminal of the user. Accordingly, it is necessary to install a feature point extraction program in the mobile terminal of the user. However, the load on the system side is reduced.

If the first aspect of the invention is modified as follows, it can be a viewing program identification system for simulcast. In other words, it is required to be a system including: a broadcast program previous reception unit configured to receive television program data from a simulcast distribution server of a broadcast station that provides the same television program on a plurality of broadcast media, M (M=5 to 10 is appropriate) seconds before the actual start of broadcasting; a feature point collection unit configured to calculate feature points of a scene image acquired at intervals of N seconds from the received television program data, and save, in a storage unit, feature point data of a predetermined time period on a broadcast station basis;

a user viewing data receiving unit configured to receive feature point data of an image of a television program a user is watching, the feature point data having been transmitted from a mobile terminal of the user; and
an image search unit configured to check the received feature point data against the saved feature point data and identify a matching scene image that satisfies a predetermined matching condition.

“Simulcast” is the broadcasting of the same program across different broadcast media on one broadcast station during the same time period. These “broadcast media” include the Internet communication network, satellite broadcasting, digital broadcasting, and CATV.

A broadcast station may provide a plurality of different television programs respectively via one or more broadcast media at the exact same time. In such a case, each television program is regarded as a “broadcast station.”

The first aspect of the invention acquires a television program that is currently on air in real time, and is different from the viewing program identification system for simulcast, which acquires a television program from a simulcast distribution server generally installed in a broadcast station several seconds before it is actually broadcast. In order to implement the viewing program identification system for simulcast, reception from the simulcast distribution server should be possible by an advance contract with a broadcast station, or the like.

A second aspect of the invention is the viewing program identification system according to the first aspect, wherein the mobile terminal acquires still image data from a moving image obtained by shooting, for N or more straight seconds, the screen on which the television program is being broadcast, and transmits feature point data calculated from the acquired still image data after a lapse of a predetermined delay time.

In the following embodiment, a description is given assuming N=1 for convenience of description. The reason why it is desirable for the mobile terminal of the user to continue shooting for N or more seconds is that the system of the present invention, which acquires the television program every N seconds, can also handle a case where the content of the broadcast has changed largely (e.g.: a commercial of Company A has been changed to a commercial of Company B).

The reason why a delay time is provided as appropriate upon transmission from the mobile terminal is that if a television program is acquired in real time as in the first aspect, feature point data may be received from the mobile terminal before storing the feature point data in the storage unit.

A third aspect of the invention is the viewing program identification system according to the first aspect, wherein the mobile terminal acquires still image data from a moving image obtained by shooting, for N or more straight seconds, the screen on which the television program is being broadcast, and transmits the acquired still image data after a lapse of a predetermined delay time,

the user viewing data receiving unit receives the still image data instead of feature point data, and

the image search unit calculates feature points of the received still image data, and checks the calculated feature point data against the feature point data recorded in the storage unit.

A fourth aspect of the invention is the viewing program identification system according to the first aspect, and

further includes a program related information database configured to store information related to a television program; and

a matching image information transmission unit configured to extract related information of a television program including the matching scene image from the program related information database and transmit the related information to the mobile terminal.

The present invention can identify the broadcast station currently being watched and the viewing time. Accordingly, various services can be provided to the user based on the information. One of such services is to provide the user with related information of a program currently being watched. The related information, if the television program is, for example, a commercial, is detailed information on a product advertised on the commercial, or a list of URLs to access the detailed information, and, if the television program is a soap opera, is a site of an online shop that can purchase clothes worn by actors appeared in the program.

A viewing program identification method of a fifth aspect and a viewing program identification program of a sixth aspect also achieve the above object of the invention.

It is possible to identify a broadcast station that a user is currently watching and a viewing time in a short time after shooting a moving image on a screen broadcast on TV with a mobile terminal. As a consequence, the range of applications of the system using multi-screen viewing is widened.

### BRIEF DESCRIPTION OF DRAWINGS

FIG. 1 is a diagram illustrating an outline of a system of a first embodiment;

FIG. 2 is a diagram illustrating functional blocks of a mobile terminal and a server of the system of the first embodiment;

FIG. 3 is a flowchart illustrating the flow of operations of the system of the first embodiment;

FIGS. 4A and 4B are diagrams illustrating data recorded in feature point data storage unit of the system of the first embodiment;

FIG. 5 is a diagram illustrating data temporarily saved in the server of the system of the first embodiment;

FIG. 6 is a diagram illustrating the flow of operations of the system of the first embodiment in association with the temporarily saved data;

FIG. 7 is a diagram illustrating an outline of a system of a second embodiment;

FIG. 8 is a diagram illustrating simulcast distribution of the second embodiment;

FIG. 9 is a diagram illustrating functional blocks of a mobile terminal and a server of the system of the second embodiment; and

FIG. 10 is a diagram illustrating operations of the system of the second embodiment in association with registered data.

### DETAILED DESCRIPTION

### First Embodiment

Hereinafter, a system of a first embodiment of the present invention (hereinafter “the system”) is described with reference to the drawings. The embodiment corresponds to the first aspect of the invention.

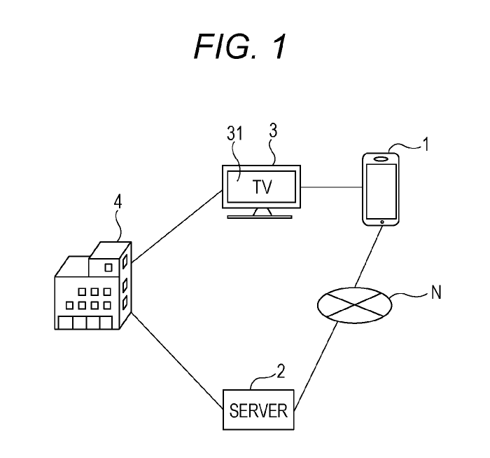

As illustrated in FIG. 1, the system includes a mobile terminal 1 used by a user, a server 2, a television receiver 3 (hereinafter the “TV 3”) watched by the user, and a broadcast station's facility 4 (hereinafter the “broadcast station 4”). The mobile terminal 1 and the server 2 are connected via the Internet N. Each of the TV 3 and the server 2 is connected to the broadcast station 4 in a wired manner or via a broadcast wave transmitting antenna (not illustrated) in a wireless manner. Television programs can be watched not only on the television receiver but also on a personal computer and a mobile terminal. However, the equipment on which the user can watch programs are collectively called the TV 3. Moreover, the TV 3 needs a dedicated tuner and decoder depending on the broadcast medium such as digital terrestrial broadcasting, 1 seg, or BS. However, their illustrations and descriptions are omitted.

An outline of the system is described with reference to FIG. 1.

In the system, when the broadcast station 4 transmits a broadcast program, the TV 3 of the user receives it and shows it on a screen 31. The broadcast program is also received by the server 2 in real time, and the server 2 acquires a scene image at predetermined intervals. Feature point data A is extracted directly from the scene image, and is stored. On the other hand, when the user shows, on the mobile terminal 1, a moving image on the screen 31, a still image is taken out by application software installed in the mobile terminal 1 to extract feature point data B by the same algorithm as that of the server 2. The mobile terminal 1 transmits the feature point data B to the server 2 after a lapse of approximately one second. The server 2 checks the stored feature point data A against the received feature point data B to identify a broadcast program the user is watching on the screen 31.

Hereinafter, the system is described in detail.

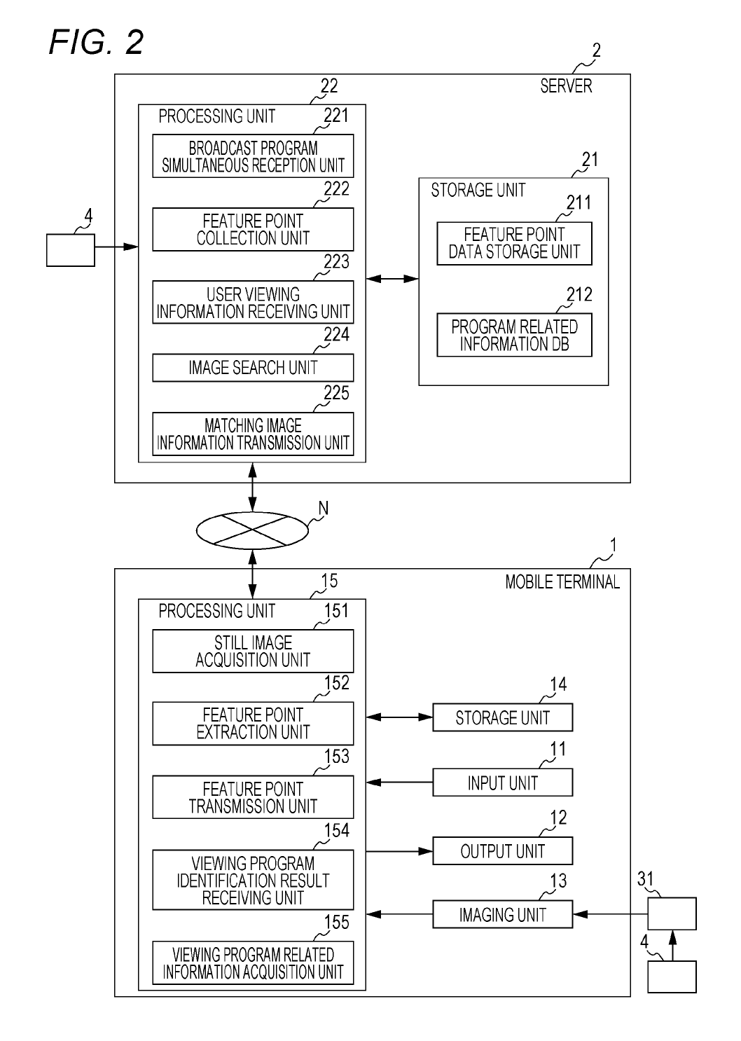

Firstly, the functions of the mobile terminal 1 and the server 2 are described with reference to FIG. 2.

The mobile terminal 1 is a portable information processing device such as a multifunction mobile phone called a smartphone.

The mobile terminal 1 includes an input unit 11, an output unit 12, an imaging unit 13, a storage unit 14, a processing unit 15, and an unillustrated communication interface unit.

The input unit 11 includes a touchscreen placed, superimposed on a screen of the output unit 12. An instruction to start/end a feature point extraction program and an access to the server 2 are provided via the input unit 11.

The output unit 12 needs a display screen, and also includes a speaker as appropriate.

The imaging unit 13 is a camera lens and an imaging device. The mobile terminal 1 used in the system needs such an image capture function.

Computer programs for implementing various processes by the processing unit 15, parameters necessary to execute these programs, intermediate results of the processes, and the like are stored in the storage unit 14.

In the embodiment, feature points of an image shot by the mobile terminal 1 are extracted by the mobile terminal 1. Therefore, it is necessary for the mobile terminal 1 to have memory necessary to execute a program that extracts feature points.

The processing unit 15 includes a still image acquisition unit 151, a feature point extraction unit 152, a feature point transmission unit 153, a viewing program identification result receiving unit 154, and a viewing program related information acquisition unit 155.

The still image acquisition unit 151 shows a moving image on the screen 31 of the TV 3, on a screen 12 using the imaging unit 13, and acquires one or more still images from the moving image.

The feature point extraction unit 152 extracts feature points of the acquired still image(s).

The feature point transmission unit 153 transmits the extracted feature point data to the server 2. A delay time of approximately one second is provided upon transmission.

If the condition matches between the feature point data transmitted to the server 2 and any of feature point data temporarily saved in a feature point data storage unit 211 (the data content is described below), information related to a television program corresponding to the transmitted feature point data is transmitted. Therefore, the viewing program identification result receiving unit 154 receives the information. For example, a case is conceivable in which if a commercial of Company A is shot, a URL of a web site including detailed information on a product of Company A is transmitted.

The viewing program related information acquisition unit 155 is a unit that accesses information related to the television program shot by the user himself/herself based on the information transmitted from the server 2. For example, if a URL is transmitted from the server 2, the viewing program related information acquisition unit 155 accesses a relevant web site based on the URL.

The classification of the units 151 to 155 included in the processing unit 15 is for convenience of description. The units are not necessarily to be clearly separated from each other. A predetermined program is installed in the mobile terminal 1 to realize these units. In other words, the system is assumed to be provided to the user in a format such as an APK file as application software (app) for a mobile terminal. The program is stored in the storage unit 14.

The server 2 is an information processing device including a storage unit 21, a processing unit 22, and an unillustrated input/output unit and communication interface unit.

The storage unit 21 includes the feature point data storage unit 211, a program related information database (hereinafter “program related information DB”) 212, a memory (not illustrated) where intermediate results of various processes, and the like are stored, a storage unit (not illustrated) of computer programs, and the like.

The feature point data storage unit 211 is described in detail below. A broadcast station, a program, a broadcast time are associated and registered in the program related information DB 212. Various pieces of information (including an URL) related to the program are also registered in the program related information DB 212 as appropriate. The data of the program related information DB 212 is broadly divided into data provided in advance from a broadcast station, and data provided after the end of broadcasting. The latter is data that program information (for example, information on actors and actresses, their clothes, and the like in a case of a soap opera) is manually registered by a staff member who monitors a television program actually broadcast.

The processing unit 22 of the server 2 includes a broadcast program simultaneous reception unit 221, a feature point collection unit 222, a user viewing information receiving unit 223, an image search unit 224, and a matching image information transmission unit 225.

The broadcast program simultaneous reception unit 221 receives a television program that is currently on air on a given number of broadcast stations in real time.

The feature point collection unit 222 extracts feature points directly from a scene image taken out from the received television program at predetermined intervals, and records feature point data of the past predetermined time period in the feature point data storage unit 211.

The user viewing information receiving unit 223 receives feature point data from the mobile terminal 1.

The image search unit 224 checks the received feature point data against the feature point data recorded in the feature point data storage unit 211, and identifies a broadcast station and viewing time corresponding to a scene image that matches the condition best (the matching scene image). A threshold value of a match rate for determining whether to match the condition, and the like are stored as parameters in the storage unit 21.

The matching image information transmission unit 225 takes out information related to the matching scene image, for example, a URL of a web site related to a television program including the scene, from the program related information DB 212, and transmits the information to the mobile terminal 1.

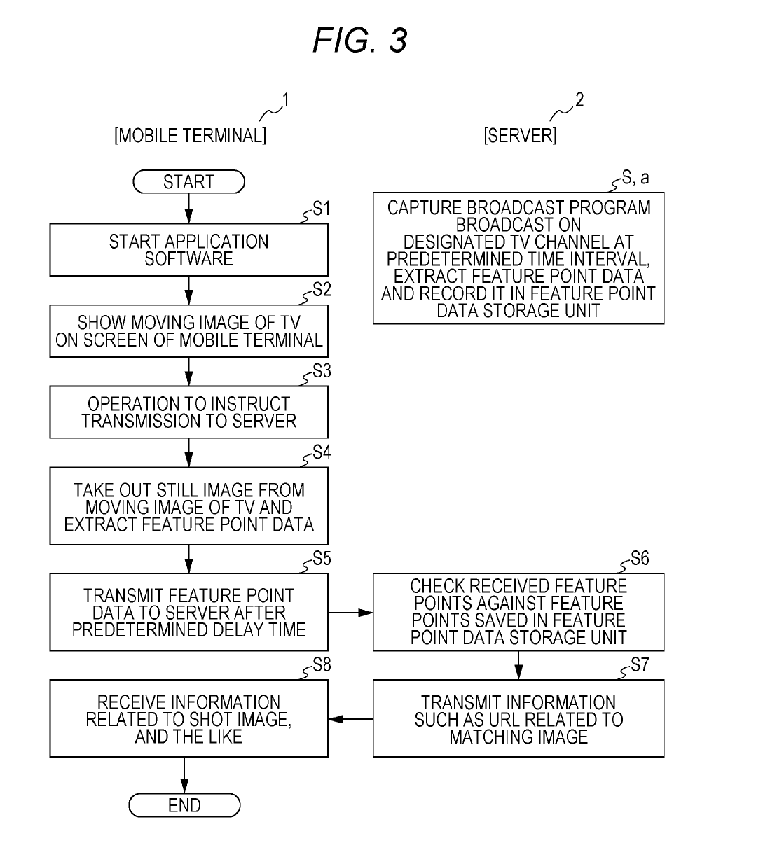

Next, the operations of the system are described with reference to FIG. 3.

The operations of the system include the following three:
Extracting and recording feature point data of a scene image obtained in real time from a television broadcast;
Checking feature point data obtained from the mobile terminal 1 against registered feature point data of the nearest scene image; and
Identifying a matching television program (including a broadcast station and a viewing time) and transmitting its related information.

Firstly, the server 2 extracts feature point data of a scene image obtained by capturing a television broadcast of a target broadcast station, and records feature point data of a predetermined time period in the feature point data storage unit 211. This is a process of step S(a) in FIG. 3. The process is performed asynchronously with processes from step S1 to step S8.

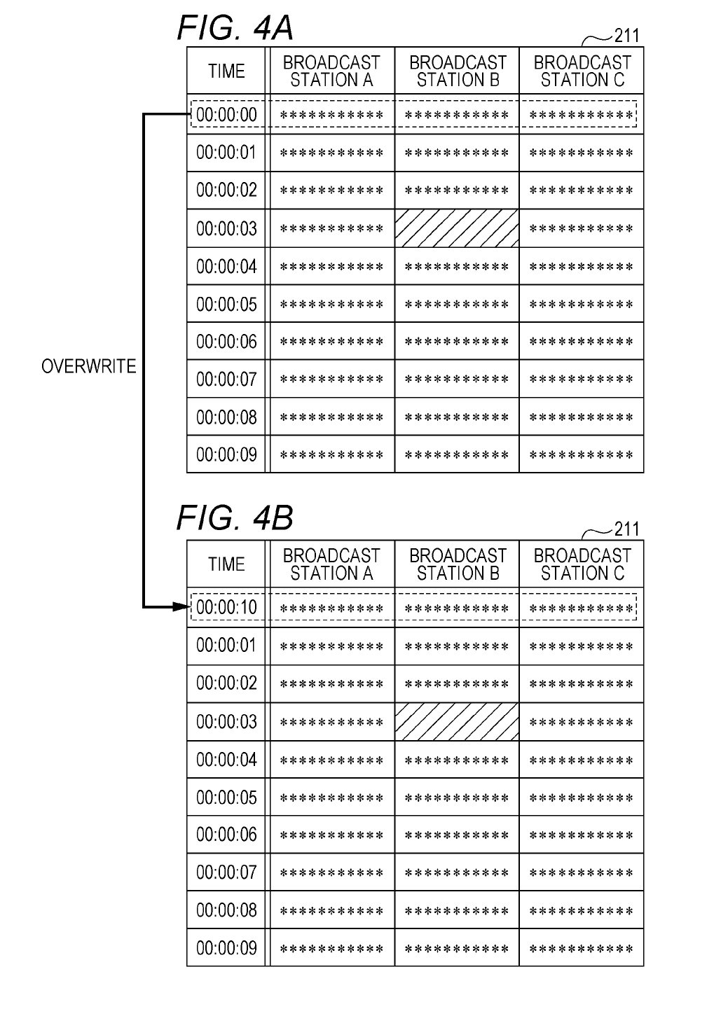

An outline of the process of capturing a television broadcast is described with reference to FIGS. 4A and 4B. The server 2 is assumed to receive television broadcasts provided respectively by Broadcast stations A, B, and C every second. FIG. 4A illustrates a state where feature point data extracted from 10 scene images captured from broadcast program data provided by each broadcast station from 00:00:00 to 00:00:09 is saved in the feature point data storage unit 211. Feature point data of a scene image transmitted by Broadcast station B at 00:00:03 is recorded in a hatched area of the figure. FIG. 4B illustrates a state where feature point data of an image captured at the time 00:00:10 is recorded (an area indicated by a broken-line rectangle). Feature point data at the latest time is overwritten on the feature point data of the time 00:00:00. In this manner, only 10 seconds' data is temporarily saved in the feature point data storage unit 211. 11-second old data is overwritten with the latest data. The saving time is not limited to 10 seconds, but may be changed depending on the operational results, as appropriate. A saving time of 5 seconds at the shortest, and approximately 60 seconds at the longest is practically sufficient.

When feature point data of six still images is transmitted from the mobile terminal 1, the server 2 does a check between feature point data 180 times (=3 broadcast stations×10 seconds×6 still images). Even if the number of target broadcast stations is 1000, the number of checks is just 60000 times.

Index data may be created using a flann (Fast Library for Approximate Nearest Neighbors) algorithm, or the like in order to do a check on feature point data at a high speed. For example, the flann algorithm is high-speed approximate calculation for k-nearest neighbor search for high dimensional features, and an index tree is created based on the flann algorithm, and checks are executed along the tree. However, the system does not create index data since feature point data to be checked per broadcast station is as small as 5 to 60 scene images.

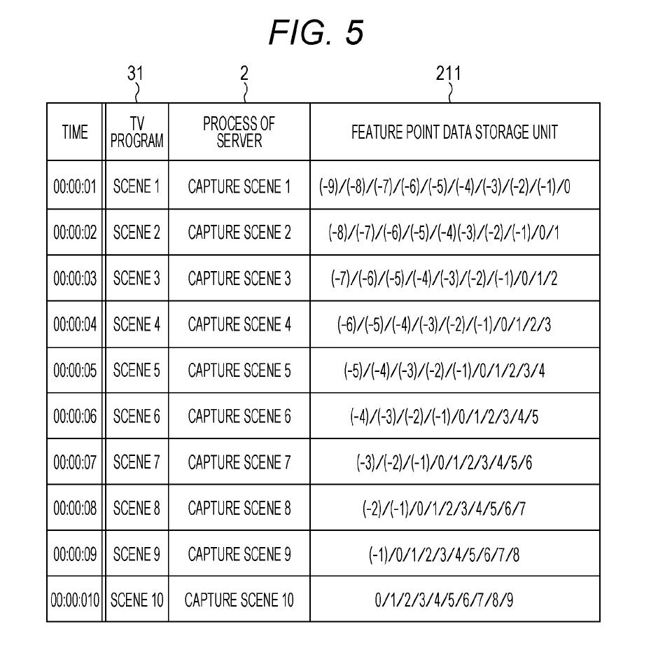

The flow of operations of when 10 seconds' data is held in the feature point data storage unit 211 is described in detail with reference to FIG. 5.

A screen broadcast at the time 00:00:00 is “scene 0,” a screen broadcast at the time 00:00:01 is “scene 1,” and “scene 2,” . . . , and so forth. Screens broadcast one second, two seconds, . . . before 00:00:00 are expressed as “scene (−1),” and “scene (−2).”

A process and recording content of the feature point data storage unit 211 of the time 00:00:01 are as follows.

The server 2 captures screen data of “scene 1” (hereinafter described as the “scene 1 image”) received from each broadcast station, extracts feature point data of the scene 1 image by the time 00:00:02, and records the extracted feature point data in the feature point data storage unit 211 (step S(a)).

At this point in time, what is saved in the feature point data storage unit 211 is feature point data of television screens broadcast nine seconds, eight seconds, . . . , one second before the time 00:00:00 and at the time 00:00:00, in other words, scene images of “scene (−9),” “scene (−8),” . . . , “scene (−1),” and “scene 0.” They are expressed as “(−9)/(−8)/(−7)/(−6)/(−5)/(−4)/(−3)/(−2)/(−1)/0” in FIG. 5.

Only 10 seconds' data is held in the feature point data storage unit 211. Accordingly, the feature point data of scene (0) is overwritten on feature point data of (scene (−10)) that was broadcast 11 seconds before 00:00:01.

A process and content saved in the feature point data storage unit 211 of the time 00:00:02 are as follows.

The server 2 captures screen data of “scene 2” received from each broadcast station, and extracts feature point data of a scene 2 image by the time 00:00:03.

What is saved in the feature point data storage unit 211 is feature point data of television screens broadcast nine seconds to one second before the time 00:00:01 and at the time 00:00:01, in other words, scene images of “scene (−8),” “scene (−7),” . . . , “scene 0,” and “scene 1.” They are expressed as “(−8)/(−7)/(−6)/(−5)/(−4)/(−3)/(−2)/(−1)/0/1” in FIG. 5.

Only 10 seconds' data is held in the feature point data storage unit 211. Accordingly, the feature point data of scene (1) is overwritten on the feature point data of (scene (−9)) that was broadcast 11 seconds before 00:00:02. From then on, the same applies to processes after 00:00:03.

In this manner, the server 2 captures broadcast program data of target broadcast stations at intervals of a predetermined time and creates in advance feature point data of scene images. The process is performed independently of the processes of steps S1 to S8 to identify a broadcast station and time that a user is currently watching.

For example, a publicly known ORB (Oriented FAST and Rotated BRIEF) algorithm is used for feature point extraction. (For details, see http://www.willowgarage.com/papers/orb-efficient-alternative-sift-or-surf, and the like.)

The ORB is a publicly known algorithm and at a level of use of a function. Accordingly, its detail is omitted.

Next, a description is given of a process where the screen's feature point data on the television screen 31 that the user is currently watching is transmitted from the mobile terminal 1 of the user, and the server 2 identifies a broadcast station, program, and viewing time that the user is watching, with reference to FIGS. 3 to 6.

The user starts predetermined application software stored in the mobile terminal 1 to receive the provision of a service of the system (step S1).

The user shoots a moving image shown on the screen 31 of the TV 3, holding a camera lens of his/her mobile terminal 1 to the moving image for one or more seconds (step S2). A television screen is captured by the server 2 every second. Accordingly, the user's shooting time needs at least one or more seconds. However, approximately two seconds are sufficient. The system is advantageous in the respect that such a short time is sufficient compared with a technology in which a fingerprint is generated and recognized, the technology requiring shooting for 6 to 10 seconds.

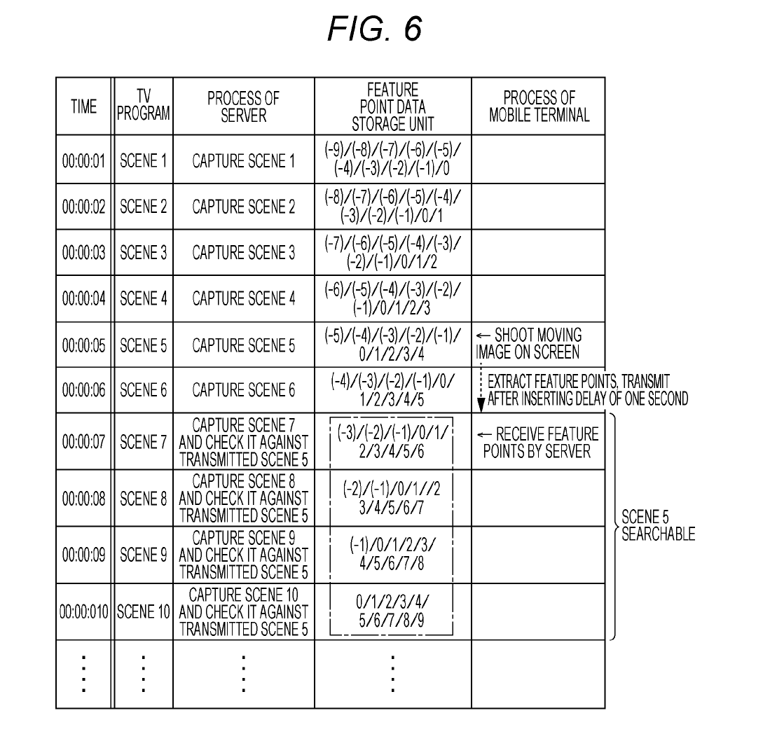

In an example of FIG. 6, the user shoots a moving image including scene 5 for one or more seconds, and transmits feature point data to the server 2. For the transmission, the user operates a button displayed on the screen of the mobile terminal 1, and the like (step S3).

One or more still images are taken out from the shot moving image at intervals of a predetermined time, triggered by the operation of step S3. Feature point data of the still image (s) is extracted (step S4). The algorithm of extraction is similar to the feature point extraction process by the server 2.

The extracted feature point data is transmitted to the server 2 after a predetermined delay time (step S5). Here the delay time is set to one second. The reason why it is desirable to insert the delay time is that if, for example, the feature point data of scene 5 is transmitted to the server 2 at 00:00:06 in FIG. 6, the feature point data of scene 5 may not have been registered yet in the feature point data storage unit 211.

On the other hand, it may take time for communication from the mobile terminal 1 of the user to the server 2, and the feature point data storage unit 211 may lose feature point data of a relevant scene image. It is desirable to decide the number of seconds for a temporary save in the feature point data storage unit 211, considering the time lag.

The server 2, which received the feature point data from the mobile terminal 1 at 00:00:07, searches the feature point data storage unit 211 for feature point data that matches the received feature point data at a predetermined threshold value or more (step S6). The user transmitted the data of scene 5. Accordingly, a search can be made between 00:00:06 and 00:00:15 during which the data of scene 5 is saved in the feature point data storage unit 211. In other words, if the check process is performed on feature point data within the saving time, a matching scene image can be obtained.

An existing algorithm disclosed in Japanese patent application No. 2012-95036 by one of the present inventors, or the like is used for the algorithm for a check between feature points. However, the angles and distances at which users shoot the screen 31 of the TV 3 vary. Therefore, a robust algorithm against scaling and rotation is desirable in which a determination process of the saving of a positional relationship, a determination process of the saving of an angle, and the like are embedded.

A scene image that matches the condition may not be found in step S6, for example, in cases of a program of a broadcast station that is not targeted by the server 2, and an old scene image lost from the feature point data storage unit 211 due to an overwrite. In these cases, an error message or the like may be transmitted to the mobile terminal 1 as appropriate.

If the server 2 can extract the feature point data of a scene image determined to match the feature point data of an image that the user is watching, the server 2 can also extract a broadcast station and time corresponding to the scene image. These pieces of information can be used for various purposes. For example, related information associated with the broadcast time of the scene image can be retrieved from the program related information DB 212 and transmitted to the mobile terminal 1 (step S7).

The mobile terminal 1 receives the provision of information related to the shot image based on the information received from the server 2 (step S8). For example, if the provided information is an URL, a web page is acquired by accessing a web server (not illustrated) based on the URL, and is displayed on the screen.

In this manner, the system can acquire and display information related to an image that shot the screen 31 being on air with the camera of the mobile terminal 1, on the spot. Accordingly, the TV3 is not passively watched as before but information can be also actively collected via the TV 3.

As described above, the embodiment can identify a broadcast station that the user is watching and a viewing time with a small time lag of, at most, several seconds by checking feature point data between still images. Consequently, various additional services can be provided to TV viewers. The kind of the service can be any. It may be to provide detailed information related to a product targeted by a commercial or to display an application screen of Internet sales, or to present information related to theme music and manufacturers of clothes and accessories worn by actors in a case of a soap opera. Alternatively, it may be to present a questionnaire on the program, or to invite participants to a quiz related to the program.

A life style of using the mobile terminal 1 while watching the TV 3 has now become common. How many business chances can be found or expanded currently depends on the speed and accuracy of the identification of a viewing program. In this respect, the present invention can be a basic technology of various systems that use multi-screen viewing.

As long as a program currently being watched can be identified by the present invention, it is also possible to obtain information such as a rating of a program, changes in the rating of the same program, and scenes preferred by users based on feature point data transmitted from many viewers. It can be not only means for advertising and sales of a sponsor company that provides a commercial but also a guideline for production and scheduling of a program.

In short, the point is that a broadcast station that a viewer is currently watching and a viewing time are speedily, correctly identified to enable contribution to greater proliferation of business using multi-screen viewing.

### Second Embodiment

A second embodiment of the present invention (hereinafter the “system”) is described. The embodiment is the first embodiment modified for simulcast, provided, for example, that a broadcast station having a simulcast distribution server, and the system have a contract to receive broadcast program data from the simulcast distribution server.

The system is different from the first embodiment in the respect of receiving broadcast program data from the simulcast distribution server at the broadcast station, preceding an actual broadcast. Hereinafter, a description is mainly given of the different points. The same reference numerals are assigned to those having the same functions as the first embodiment in the following description and drawings.

As illustrated in FIG. 7, the system includes the mobile terminal 1 used by a user, a server 5, the TV 3 watched by the user, and a broadcast station's facility 6 (hereinafter the “broadcast station 6”). The mobile terminal 1 and the server 5 are connected via the Internet N. Each of the TV 3 and the server 2 is connected to a simulcast distribution server 61 installed in the broadcast station 6.

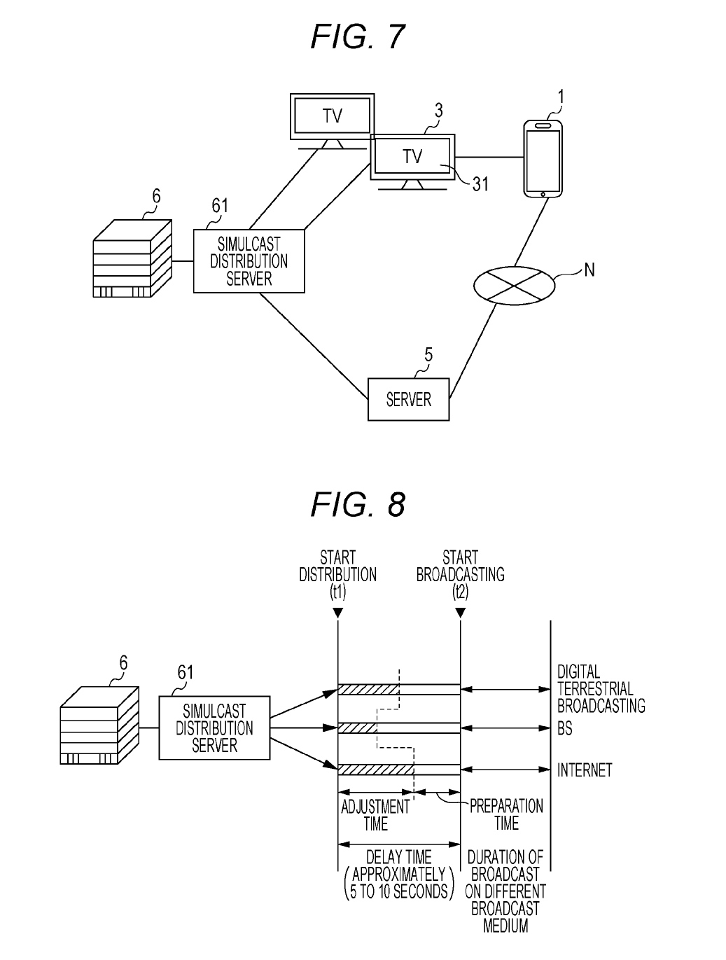

In the embodiment, broadcast program data is received from the simulcast distribution server 61, and accordingly a viewing program can be identified in substantially real time. Grounds for achieving substantially real-time identification are described with reference to FIG. 8. In a case of live simulcast, a delay time including an adjustment time and a preparation time for each broadcast medium is required to simultaneously watch broadcast program data output from the simulcast distribution server 61 at the user, as illustrated in FIG. 8. The use of the delay time makes it possible to take out a still image (scene image) contained in moving image data actually distributed directly from the simulcast distribution server 61 at fixed or necessary intervals, extract feature points of the image, and temporarily save them in a feature point data storage unit 511. Hence, a program broadcast after the delay time is almost simultaneously shown on TV even on different broadcast media. Shooting is performed by the mobile terminal 1 and feature points are extracted. The extracted data is subsequently transmitted to the server 5. A check then becomes possible to be done.

An appropriate delay time is approximately 5 to 10 seconds.

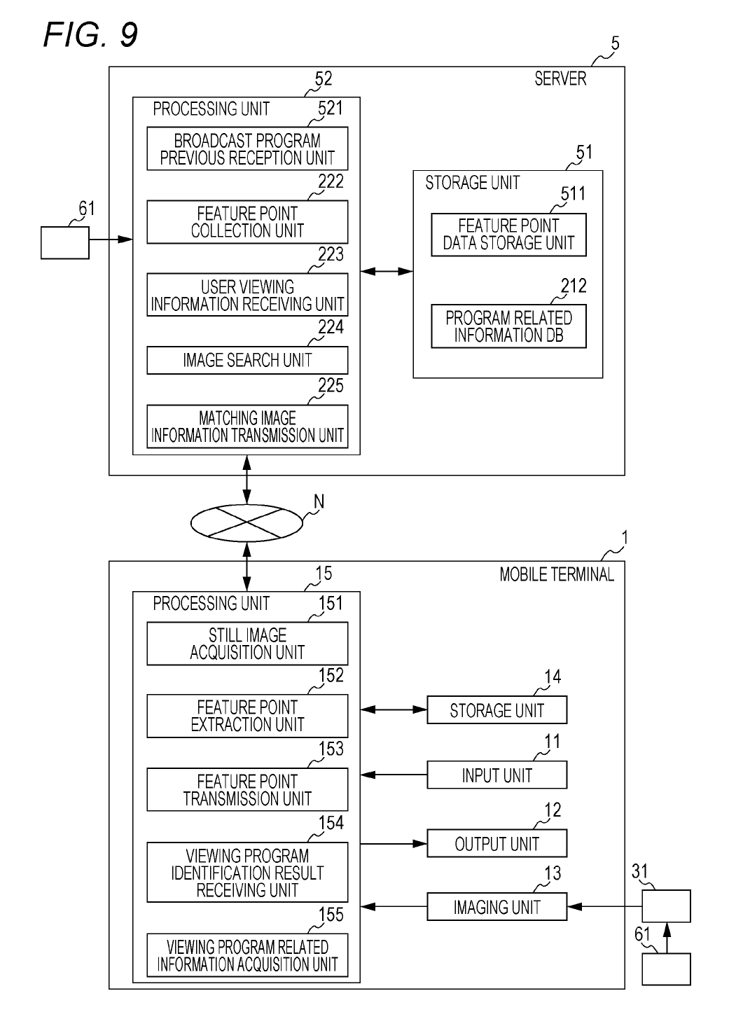

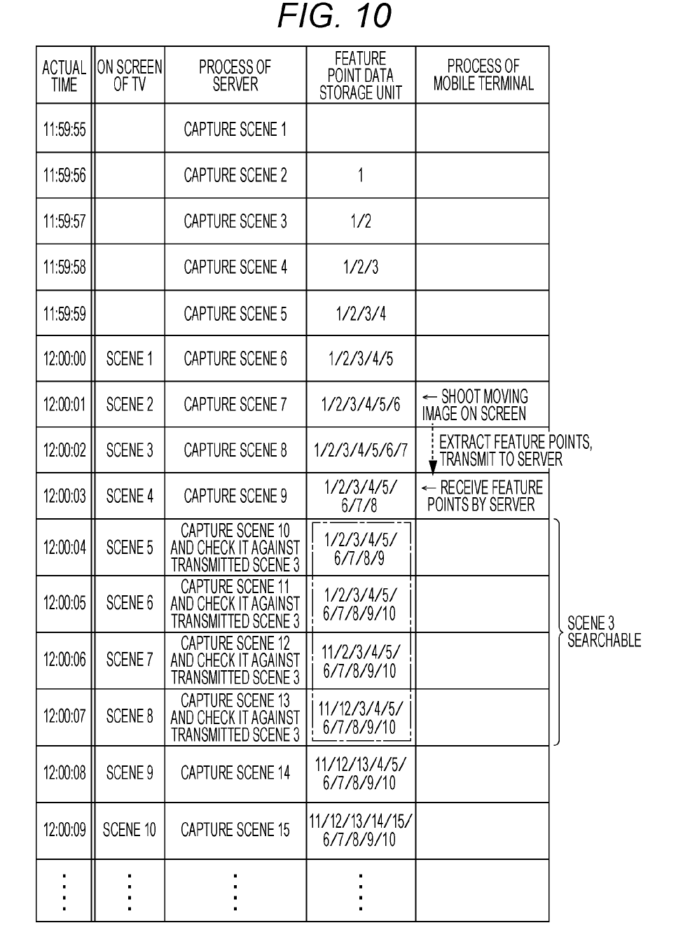

FIG. 9 illustrates functional blocks of the mobile terminal 1 and the server 5. The mobile terminal 1 is not different from the first embodiment. Accordingly, its description is omitted.

The server 5 is an information processing device including a storage unit 51, a processing unit 52, and an unillustrated input/output unit and communication interface unit.

The storage unit 51 includes a feature point data storage unit 511, the program related information database (hereinafter “program related information DB”) 212, a memory (not illustrated) in which intermediate results of various processes, and the like are stored, a storage unit (not illustrated) of computer programs, and the like.

The feature point data storage unit 511 is described in detail below.

The processing unit 52 of the server 5 includes the broadcast program previous reception unit 521, the feature point collection unit 222, the user viewing information receiving unit 223, the image search unit 224, and the matching image information transmission unit 225.

The broadcast program previous reception unit 521 receives a broadcast content several seconds before the broadcast content is distributed from the simulcast distribution server 61 to the TV 3 and starts being broadcast.

Next, operations of the system are described focusing on the different points from the first embodiment, with reference to FIG. 10.

Firstly, the server 5 receives, from the simulcast distribution server 61, broadcast program data scheduled to be broadcast several seconds later. The data scheduled to be broadcast at the time of t2 of FIG. 8 is received at the time of t1. The reception target is image data before splitting into broadcast media from the simulcast distribution server 61. Therefore, information registered in the feature point data storage unit 511 contains a “broadcast station”, but does not contain a “broadcast medium.”

In the embodiment, data to be broadcast at 12:00:00 (data of “scene 1”) is received at 11:59:55 that is five seconds before. Feature points are calculated to be registered in the feature point data storage unit 511. Data of “scene 2” to be broadcast at 12:00:01 is received at 11:59:56. Feature points are calculated to be registered in the feature point data storage unit 511. Data of “scene 3,” “scene 4,” . . . is also similarly processed.

15 seconds' data at the maximum is registered in the feature point data storage unit 511.

If the mobile terminal 1 shows the image of “scene 3” shown on the screen 31 at 12:00:02, on the screen of the mobile terminal 1, feature point data calculated on the mobile terminal 1 side is transmitted to the server 5. In the embodiment, a delay does not need to be inserted upon transmission. In other words, a delay time S=0.

If the server 5 receives the data at 12:00:04, the data can be searched during a time period when the data of “scene 3” is registered in the feature point data storage unit 511 up to 12:00:12.

The process from the shooting of the screen 31 on the mobile terminal 1 side to the transmission of feature point data to the server 5, and the process of the server 5's identifying a broadcast station that the user is watching and a viewing time are similar to the first embodiment (see steps S1 to S8 of FIG. 3). Accordingly, their descriptions are omitted. Moreover, the process of the server 5's overwriting feature point data of a predetermined time-old scene image with the latest feature point data is also similar to the first embodiment. Accordingly, its description is omitted.

The embodiment is superior to the first embodiment in the following point.

In an example of FIG. 10, the image of scene 1 is shown on the screen 31 at the time 12:00:00. However, the data of scene 6 is transmitted from the simulcast distribution server 61 to the server 5 at the exact same time. In this manner, a delay of five seconds is occurring. Accordingly, before a scene is output to the screen 31, feature point data of the scene is saved in the feature point data storage unit 511 of the server 5. Hence, there will be no waiting time upon a check of feature point data transmitted from the mobile terminal 1 against feature point data saved in the server 5, and a real time property improves.

Up to this point the first and second embodiments have been described. The server 2 of the first embodiment may also include the broadcast program previous reception unit 521 included in the server 5 of the second embodiment. Reception is performed in advance from a broadcast station under contract to receive from a simulcast distribution server, several seconds before broadcasting. Reception is performed simultaneously with broadcasting from a broadcast station that is not under contract or that does not include a simulcast distribution server. Accordingly, any kind of broadcast can be handled regardless of the presence or absence of the contract.

It is desirable for a general user to be able to obtain information on a television program that the user is currently watching also from a mobile terminal in parallel. Whether or not a broadcast station that is providing the television program is under contract to the system of the present invention does not matter to the user.

Moreover, it is desirable that the system of the present invention be provided to each area of prefectures in order to be widely used not only in specific areas. This is because each area has local broadcast stations. For example, it may be configured such that when a mobile terminal transmits a current location together with feature point data by its GPS function, if the user's current location is Shibuya, Tokyo, a server that has control within Tokyo (excluding the islands) performs the check process.

The process flows and algorithms of the first and second embodiments are simply shown by example. The process flows and algorithms are not limited them. For example, in the embodiments, the screen 31 is shot by an application program installed on the mobile terminal 1 side to acquire a still image. Accordingly, feature point data of the still image is extracted. However, the still image may be transmitted to the server 2 or 5 to extract feature points in the server 2 or 5.

In the embodiments, both the process of capturing television program data received from a broadcast station, creating feature point data, and temporarily saving the feature point data in the feature point data storage unit 211 or 511 and the process of identifying a viewing program based on data transmitted from the mobile terminal 1 are assumed to be performed on one computer (see FIG. 6, for example, the process of the time 00:00:07). However, a plurality of computers may share the functions of the server 2 or 5 for processing.

In recent years, multi-screen viewing has become common. The present invention that can identify a broadcast station that is currently being watched on TV and a viewing time in substantially real time is used to significantly widen the range of applications of the system using multi-screen viewing. For example, even in the provision of a service related to a viewing program, the kinds of its service range widely. It can also be expected to bring a large change in consumer activities.

What is claimed is:

1. A viewing program identification system configured to shoot a screen showing a television program that is currently on air and being watched by a user with a mobile terminal, acquire a still image from the shot moving image, and identify the television program being watched by the user in substantially real time based on feature point data calculated from the still image, the system comprising:
a broadcast program simultaneous reception unit configured to receive television program data that is currently on air on a given number of broadcast stations;
a feature point collection unit configured to calculate feature points of a still image of a screen (hereinafter a “scene image”) acquired from the received television program data at intervals of N seconds in real time, and save, in a storage unit, feature point data of a predetermined time period immediately before the current broadcast on a broadcast station basis;
a user viewing data receiving unit configured to receive the feature point data of the still image acquired from the television program being watched by the user, the feature point data having been transmitted from the mobile terminal of the user; and
an image search unit configured to check the received feature point data against the saved feature point data and identify a scene image that satisfies a predetermined matching condition (hereinafter the “matching scene image”) to identify the television program currently being watched by the user.

2. The viewing program identification system according to claim 1, wherein the mobile terminal acquires still image data from a moving image obtained by shooting, for N or more straight seconds, the screen on which the television program is being broadcast, and transmits feature point data calculated from the acquired still image data after a lapse of a predetermined delay time.

3. The viewing program identification system according to claim 1, wherein the mobile terminal acquires still image data from a moving image obtained by shooting, for N or more straight seconds, the screen on which the television program is being broadcast, and transmits the acquired still image data after a lapse of a predetermined delay time,
the user viewing data receiving unit receives the still image data instead of feature point data, and
the image search unit calculates feature points of the received still image data, and checks the calculated feature point data against the feature point data recorded in the storage unit.

4. The viewing program identification system according to claim 1, further comprising:
a program related information database configured to store information related to a television program; and
a matching image information transmission unit configured to extract related information of a television program including the matching scene image from the program related information database and transmit the related information to the mobile terminal.

5. A viewing program identification method for shooting a screen showing a television program that is currently on air and being watched by a user with a mobile terminal, acquiring a still image from the shot moving image, and identifying the television program being watched by the user in substantially real time based on feature point data calculated from the still image, the method in which a computer executes:
receiving television program data that is currently on air on a given number of broadcast stations;
calculating feature points of a scene image acquired from the received television program data at intervals of N seconds in real time, and saving, in a storage unit, feature point data of a predetermined time period immediately before the current broadcast on a broadcast station basis;
receiving the feature point data of the still image acquired from the television program being watched by the user, the feature point data having been transmitted from the mobile terminal of the user; and
checking the received feature point data against the saved feature point data and identifying a matching scene image that satisfies a predetermined matching condition to identify the television program currently being watched by the user.

6. A recording medium configured to store a computer program for causing a computer to shoot a screen showing a television program that is currently on air and being watched by a user with a mobile terminal, acquire a still image from the shot moving image, and identify the television program being watched by the user in substantially real time based on feature point data calculated from the still image, the recording medium being configured to store a viewing program identification program causing the computer to implement the functions of:
receiving television program data that is currently on air on a given number of broadcast stations;
calculating feature points of a scene image acquired from the received television program data at intervals of N seconds in real time, and saving, in a storage unit, feature point data of a predetermined time period immediately before the current broadcast on a broadcast station basis;
receiving the feature point data of the still image acquired from the television program being watched by the user, the feature point data having been transmitted from the mobile terminal of the user; and
checking the received feature point data against the saved feature point data and identifying a matching scene image that satisfies a predetermined matching condition to identify the television program currently being watched by the user.
